(19) United States
(12) Patent Application Publication
(10) Pub. No.: US 2013/0202871 A1
(43) Pub. Date: Aug. 8, 2013

(54) POLYIMIDE SHEET AND MANUFACTURING METHOD THEREOF

(71) Applicant: E I DU PONT DE NEMOURS AND COMPANY, Wilmington, DE (US)

(72) Inventors: Shorato HIDAKA, Aichi (JP); Michio OHTA, Kanagawa (JP)

(73) Assignee: E I DU PONT DE NEMOURS AND COMPANY, Wilmington, DE (US)

(21) Appl. No.: 13/753,891

(22) Filed: Jan. 30, 2013

(30) Foreign Application Priority Data
Feb. 3, 2012 (JP) 2012-21622

(51) Int. Cl. C08L 79/08; B32B 27/08

(52) U.S. Cl. CPC C08L 79/08; B32B 27/08
USPC 428/220; 156/60

(57) ABSTRACT

[Problem]

An object of the present invention is to provide a polyimide sheet with substantially isotropic physical properties, and to provide a method of manufacturing thereof.

[Resolution Means]

A polyimide sheet formed by laminating at least two polyimide films, such that a thickness of the polyimide sheet is at least 0.2 mm, and a linear expansion coefficient in two orthogonal directions in any plane is at most 10 ppm/° C.

### BACKGROUND

1. Field of the Invention

The present invention relates to a polyimide sheet that is isotropic in the planar direction, and to a manufacturing method thereof.

2. Background

Polyimide resins are films with superior heat resistance, tribological properties, and chemical resistance, and these are used in various applications. However, general polyimide resins develop isotropic physical properties in their manufacturing process, so the physical properties are almost identical in the X, Y, and Z directions.

As a result, there is a problem such that the linear expansion coefficient fails to exhibit the properties required for applications that require low dimensional stability only in the planar direction.

In response to this problem, it has been proposed (see Japanese. Unexamined Patent Application Publication No. 2011-167903, Japanese Unexamined Patent Application Publication No. 2011-167904, and Japanese Unexamined Patent Application Publication No. 2011-167905) that a resinous state be formed by laminating a plurality of polyimide films. These patents propose a resin with a lower coefficient of thermal expansion in the planar direction than those of conventional polyimide resins. However, there was a problem that a difference was noticeable in the direction orthogonal to the planar direction.

Moreover, a coefficient of thermal expansion of 10 ppm/° C. or lower is sometimes required in resins used in an elevated temperature environment, and these requirements were not satisfied.

### BACKGROUND DOCUMENTS

### Patent Documents

Patent Document 1: Japanese Unexamined Patent Application Publication No. 2011-167903

Patent Document 2: Japanese Unexamined Patent Application Publication No. 2011-167904

Patent Document 3: Japanese Unexamined Patent Application Publication No. 2011-167905

### SUMMARY OF THE INVENTION

### Problems to be Solved by the Invention

An object of the present invention is to provide a polyimide sheet with substantially isotropic physical properties, and to provide a method of manufacturing thereof.

### SUMMARY

That is, the present invention is configured as follows.

A polyimide sheet formed by laminating at least two polyimide films, such that a thickness of the polyimide sheet is at least 0.2 mm, and a linear expansion coefficient in any two orthogonal direction in a plane is at most 10 ppm/° C.

A method of manufacturing a polyimide sheet, comprising pressing a polyimide sheet after laminating at least two polyimide films, wherein, when laminating the polyimide films, a film to be laminated is laminated essentially at a 70 to 90 degree angle in a planar direction of the film, centered on a desired point of the laminated film, relative to the laminated film.

### EFFECT OF THE INVENTION

With the present invention, it is possible to obtain a polyimide sheet with an in-plane linear expansion coefficient that is at most 10 ppm/° C., so the polyimide sheet obtained by the present invention is suitable for use when silicon and glass are to be matched. The polyimide sheet obtained by the present invention can be used in electronic component applications and the like, where dimensional stability is required at elevated temperatures.

### DETAILED DESCRIPTION

The polyimide sheet of the present invention will be described concretely in the following.

The polyimide sheet of the present invention is obtained by laminating at least two polyimide films, such that a thickness of the polyimide sheet is at least 0.2 mm, and a linear expansion coefficient in any two orthogonal direction in a plane is at most 10 ppm/° C.

In the polyimide sheet of the present invention, a number of laminated polyimide films is preferably from 2 to 10,000, more preferably from 5 to 6000, even more preferably from 10 to 3000, and still even more preferably from 20 to 800.

The thickness of the polyimide sheet of the present invention is preferably from 0.2 to 20 mm, more preferably from 0.3 to 15 mm, and even more preferably from 0.5 to 10 mm.

The polyimide film used in the polyimide sheet of the present invention is not particularly limited to a manufacturing method, and is manufactured by using a generally known method. For example, the film is generally formed by extruding in the form of a casting or film a polyamide acid solution prepared by reacting a dianhydride or a diamine, drying, heat-treating, and then proceeding to imidization. At this time, drying and heat treatment can be achieved by passing through a dry heat treatment zone maintained at an elevated atmospheric temperature of 200 to 600° C., preferably 250 to 550° C., the polyamide solution obtained by extruding in a casting or film form. Moreover, the film undergoing drying and heat treatment may be stretched by any scaling factor during the process that transitions from polyamic acid to polyimide.

Generally known imidization methods include a thermal cyclization method that dehydrates by heating and a chemical ring closing method that chemically dehydrates by using a dehydrating agent and an imidization catalyst. However, the imidization method used in the present invention is not particularly limited. However, when reducing the linear expansion coefficient of a film, the chemical ring closing method is preferred.

The preferable imidization catalyst is a tertiary amine. Specific examples include trimethylamine, triethylamine, triethylene diamine, pyridine, isoquinoline, 2-ethyl pyridine, 2-methyl pyridine, N-ethyl morpholine, N-methyl morpoline, diethylcyclohexylamine, N-dimethylcyclohexylamine, 4-benzoyl pyridine, 2,4-lutidine, 2,6-lutidine, 2,4,6-collidine, 3,4-lutidine, 3,5-lutidine, 4-methyl pyridine, 3-methyl pyridine, 4-isopropyl pyridine, N-dimethyl benzylamine, 4-benzyl pyridine, and N-dimethyl decylamine, among others. In addition, examples of dehydrating agents are organic carboxylic acid anhydrides, N,N-dialkylcarbodiimides, lower fatty acid halides, halogenated lower fatty acid halides, halogenated lower fatty acid anhydrides, aryl phosphoric acid dihalides, and thionyl halides.

Specific examples of the dianhydride constituting the polyimide film used in the present invention are pyromellit dianhydride, 3,3′,4,4′-biphenyltetracarbon dianhydride, 2,3′,3,4′-biphenyl tetracarbon dianhydride, 2,2′,3,3′-biphenyl tetracarbon dianhydride, 2,3,6,7-naphthalene tetracarbon dianhydride, 2,2′-bis(3,4-dicarboxyphenyl)propane dianhydride, bis(3,4-dicarboxyphenyl)sulfone dianhydride, 3,4,9,10-perylenetetracarbon dianhydride, bis(3,4-carboxyphenyl)ether dianhydride, naphthalene-1,2,45-tetracarbon dianhydride, naphthalene-1,4,5,8-tetracarbon dianhydride, decahydronaphthalene-1,4,5,8-tetracarbon dianhydride, 4,8-dimethyl-1,2,3,5,7-hexahydronaphthalene-1,2,5,6-tetracarbon dianhydride, 2,6-dichloronaphthalene-1,4,5,8-tetracarbon dianhydride, 2,7-dichloronaphthalene-1,4,5,8-tetracarbon dianhydride, 2,3,6,7-tetrachloronaphthalene-1,4,5,8-tetracarbon dianhydride, phenanthrene-1,8,9,10-tetracarbon dianhydride, 2,2-bis(2,3-dicarboxyphenyl)ethane dianhydride, 1,1-bis(3,4-dicarboxyphenyl)ethane dianhydride, bis(2,3-dicarboxyphenyl)methane dianhydride, bis(3,4-dicarboxyphenyl)methane dianhydride, bis(3,4-dicarboxyphenyl)sulfone dianhydride, benzene-1,2,3,4-tetracarbon dianhydride, 3,4,3,4′-benzophenone tetracarbon dianhydride, among others. These may be used individually or in combinations of two or more.

Of these dianhydrides, the preferable ones are pyromellit dianhydride and 3,3′,4,4-biphenyltetracarbon dianhydride. Of all acid components of the polyimide film used in the present invention, a form that contains from 0 to 90 mol % pyromellitic acid component is preferable; a form that contains from 10 to 80 mol % is more preferable; and a from containing from 20 to 80 mol % is even more preferable. Also, the 3,3′,4,4′-biphenyltetracarbonic acid component is preferably from 0 to 80 mol %, more preferably from 5 to 50 mol %, and more preferably from 5 to 40 mol %.

Examples of the diamine component comprising the polyimide film used in the present invention are 4,4′-diaminodiphenyl ether, paraphenylene diamine, 3,4′-diaminodiphenyl ether, methaphenilene diamine, 4,4′-diaminodiphenyl propane, 4,4′-diaminodiphenyl methane, benzidine, 4,4′-diaminodiphenyl sulfide, 4,4′-diaminodiphenyl sulfone, 3,3′-diaminodiphenyl sulfone, 2,6-diaminopyridine, bis-(4-aminophenyl)diethylsilane, bis-(4-aminophenyl)diphenylsilane, 3,3′-dichlorobenzidine, bis-(4-aminophenyl)ethylphosphine oxide, bis-(4-aminophenyl)phenylphosphine oxide, bis-(4-)-N-phenylamine, bis-(4-aminophenyl)-N-methylamine, 1,5-diaminonaphthalene, 3,3′-dimethyl-4,4′-diaminobiphenyl, 3,4′-dimethyl-3′,4-diaminobiphenyl, 3,3′-dimethoxybenzidine, 2,4-bis(13-amino-t-butyl)toluene, bis(p-beta-amino-t-butyl-phenyl)ether, p-bis-(2-methyl-4-amino-bentyl)benzene, p-bis-(1,1-dimethyl-5-aminobentyl)benzene, m-xylylenediamine, p-xylylene diamine, 1,3-diaminoadamantane, 3,37′-diamino-1,17-diadamantane, 3,3′-diamino 1,1′-diadamantane, bis(p-amino-cyclohexyl)methane, hexamethylene diamine, peptamethylene diamine, octamethylene diamine, nonamethylene diamine, decamethylene diamine, 3-methylheptamethylene diamine, 4,4-dimethyiheptamethylene diamine, 2,11-diaminododecane, 1,2-bis-(3-amino-propoxy)ethane, 2,2-dimethylpropylene diamine, 3-methoxyhexamethylene diamine, 2,5-dimethyl hexamethylene diamine, 5-methyl nonamethylene diamine, 5-methyl nonamethylene diamine, 1,4-diaminocyclohexane, 1,12-diamino-octadecane, 2,5-diamino-1,3,4-oxadiazole, 2,2-bis(4-aminophenyl)hexafluoro propane, N-(3-aminophenyl)-4-aminobenzamide, 4-aminophenyl-3-aminobenzoate, among others. These many be used independently or in combinations of two or more.

Of these diamines, 4,4′-diaminodiphenylether and paraphenylenediamine are preferable. Of all the diamine components of the polyimide film used in the present invention, a preferable form is one that contains from 0 to 95 mol % of 4,4′-diaminodiphenylether, more preferably from 10 to 90 mol %, and still more preferably from 20 to 85 mol %. Moreover, the paraphenylenediamine component is preferably from 0 to 90 mol %, more preferably from 5 to 50 mol %, and still more preferably from 5 to 40 mol %.

Regarding the polyimide film of the present invention, inorganic particles or another additive can be added in any process, as long as this addition is before cyclization and desolvation to polyimide of polyamic acid, the precursor. Regarding a preferable form of the additive at this time, it is preferable to add inorganic particles with a particle diameter of at most 3.0 μm, in a proportion of 0.1 to 0.9 wt % per weight of film resin.

In addition, although a thickness of the polyimide film of the present invention is not particularly specified, if the polyimide film is too thin the number of laminated layers will increase, and therefore air bubbles will occur, which might worsen the yield of polyimide sheet. Moreover, if too thick, phase separation will occur within the polyimide film and the resulting adhesive force might be insufficient, and therefore, a thickness of 2 to 250 μm is preferable. Furthermore, from 5 to 200 μm is more preferable, from 10 to 100 pm is even more preferable, and from 10 to 50 μm is even more preferable.

The coefficient of thermal expansion of the polyimide film used in the polyimide sheet in the present invention preferably has a linear expansion coefficient in the tensile mode in at least one planar direction of at least 10 ppm/° C. Furthermore, it is more preferable to use a polyimide film having a linear expansion coefficient in one planar direction of at least 10 ppm/° C. and also having a linear expansion coefficient in a direction orthogonal thereto of at most 10 ppm/° C. Furthermore, it is even more preferable to use a polyimide film having a linear expansion coefficient in one planar direction of at least 10 to 15 ppm/° C. and also having a linear expansion coefficient in a direction orthogonal thereto of 3 to 8 ppm/° C.

The polyimide sheet in the present invention is preferably as follows, when αT is a modulus of elasticity in a direction TD (transverse direction) and αM is a modulus of elasticity in a direction MD (machine direction), in a bend test of a polyimide sheet obtained by laminating polyimide films in a same direction, and when β2 is a modulus of elasticity in a direction orthogonal to β1 and β1, which are moduli of elasticity in desired directions, in a bend test of a polyimide sheet obtained by laminating after rotating each polyimide film one at a time to a desired angle:

(αM+αT)/2)−0.5[GPa]≦β1≦(αM+αT)/2)+0.5[GPa],

and

(αM+αT)/2)−0.5[GPa]≦β2≦(αM+αT)/2)+0.5[GPa].

Moreover, a tensile modulus of the polyimide film that forms the polyimide sheet in the present application is preferably from 3 to 10 GPa, in both the MD and TD directions. The tensile modulus is more preferably from 4 to 9 GPa, and even more preferably is from 5 to 8 GPa.

The polyimide sheet in the present invention is preferably as follows, when yT is a maximum stress in the direction TD and yM is a maximum stress in the direction MD, in a bend test of a polyimide sheet obtained by laminating polyimide films in a same direction, and when δ2 is a maximum stress in a direction orthogonal to δ1 and δ1, which are maximum stresses in desired directions, in a bend test of a polyimide sheet obtained by laminating after rotating each polyimide film one at a time to a desired angle:

(γM+γT)/2)−20[MPa]≦δ1≦(γM+γT)/2)+20[MPa],

and

(γM+γT)/2)−20[MPa]≦δ2≦(γM+γT)/2)+20[MPa].

The maximum stress in a tensile test of the polyimide film constituting the polyimide sheet in the present application is preferably from 330 to 490 MPa in both the MD and TD directions. The maximum stress more preferably is from 350 to 470 MPa, and even more preferably is from 370 to 450 MPa.

The polyimide sheet in the present invention is preferably as follows, when εT is the modulus of elasticity in the direction TD and εM is the modulus of elasticity in the direction MD, in the tensile test of the polyimide sheet obtained by laminating polyimide films in the same direction, and when ζ2 is the modulus of elasticity in a direction orthogonal to ζ1 and ζ1, which are the moduli of elasticity in desired directions, in the tensile test of the polyimide sheet obtained by laminating after rotating each polyimide film one at a time to a desired angle:

(εM+εT)/2)−1.0[GPa]≦ζ1≦(εM+εT)/2)+1.0[GPa],

and

(εM+εT)/2)−1.0[GPa]≦ζ2≦(εM+εT)/2)+1.0[GPa]

The polyimide sheet of the present invention is as follows, when ηT is the maximum stress in the direction TD and ηM is the maximum stress in the direction MD, in the tensile test of the polyimide sheet obtained by laminating polyimide films in the same direction, and when θ2 is the maximum stress in a direction orthogonal to θ1 and θ1, which are the maximum stresses in desired directions, in the tensile test of the polyimide sheet obtained by laminating after rotating each polyimide film one at a time to a desired angle:

(ηM+ηT)/2)−1.0[GPa]≦θ1≦(ηM+ηT)/2)+30[MPa],

and

(ηM+ηT)/2)−1.0[GPa]≦θ2≦(ηM+ηT)/2)+30[MPa].

One feature of the present invention is that, when a polyimide sheet is laminated, a film laminated on another film to be laminated upon is laminated substantially at an angle, with a desired point on a plane of the film to be laminated upon as the center, and films are laminated by repeating this process. This process is essential to imparting an isotropic property using anisotropic films. As a result of this process, the pressed polyimide sheet exhibits isotropic physical properties.

In addition, when the thicknesses of the polyimide films vary, when they are laminated in the same direction and then pressed, there is insufficient adhesive force between films, which is attributable to the variation in thickness. Therefore, the process of laminating at an angle is important to average the variation in film thickness.

The lamination method is not particularly limited, and lamination may be at an angle. For example, in the process of laminating after cutting a roll of film to a desired length, the process is such that a second film is laminated onto a first film, in a state in which the second film has been rotated by 10° and centered upon a desired point on the first film.

In this case, the angle can be freely set. The angle need not be fixed, and a desired angle may be set for each laminated film.

To equalize the coefficients of thermal expansion in the planar direction, it is preferable to laminate after rotating from 70° to 110°. A method that laminates after rotating from 80° to 100° is more preferable.

Moreover, either a positive or negative angle direction may be selected, and a desired direction may be selected for each laminated film,

To average out variations in the polyimide film thickness, it is preferable to set the angle direction only in either the positive or the negative direction.

Furthermore, the film direction may be set freely, and lamination can be performed after changing surface A (the surface facing vertically upward relative to the direction of transport during film manufacture) and surface D (the surface facing vertically downward relative to the direction of transport during film manufacture) as desired.

The polyimide films curl vertically upward and vertically downward during film formation. Therefore, a preferable lamination method switches surface A and surface D each film.

When the polyimide sheet in the present invention is manufactured, both surfaces of the polyimide film forming the polyimide sheet may be subjected to surface treatment.

The present invention is obtained using polyimide film, by laminating successive films, with directions MD and TD mutually orthogonal, and then subjecting to thermocompression bonding. The compression means at that time is a method such that a laminated film formed by laminating cut films at desired angles in the MD and TD directions is inserted between planar hot plates, and pressing is performed using a cylinder or the like to apply pressure. In addition, when this method is used, it is preferable to heat and pressurize in a vacuum, to avoid defects such as air bubbles in the obtained polyimide sheet. Moreover, to reduce pressure variation in the plane, a mirror plate, cushion plate, or the like may be used either above or below or within the laminated polyimide film.

### EXAMPLES

The present invention will be described concretely below, based on embodiments. However, the present invention is not limited to only these embodiments. Moreover, the physical properties of the sheet were measured in accordance with the following method.

### (Flexural Modulus and Flexural Strength)

The flexural modulus and flexural strength were in accordance with ASTMD 690. The test piece size was t 3.2 mm×W 12.7 mm×L 63.5 mm, and a universal tester was used, The speed was 5 mm/minute, and the modulus of elasticity was calculated by applying the least-squares method to the value at this time within the range of 10 to 20 MPa.

### (Coefficient of Thermal Expansion)

A TMA was used for measurement from room temperature up to 400° C., at a 5° C./min rate of temperature increase. The value of the 50 to 200° C. average expansion at that time was used as the coefficient of thermal expansion.

### Example 1

Kapton 150EN-AJ made by Du Pont-Toray Co., Ltd. was cut to 60 cm, and 150 films were successively superimposed so as to be orthogonal in the MD and TD directions. Cushioning materials 3 mm thick, made of glass Teflon, were placed above and below, and a vacuum press made by Kitagawa Seiki Co., Ltd. was used to press for 30 minutes under conditions of 350° C. and 130 kg/cm². After this was cooled to 100° C., the pressure was released, and the polyimide sheet was removed. The physical properties of the obtained polyimide sheet are listed in Table 1. Furthermore, Table 1 lists average values for the coefficient of thermal expansion, flexural modulus, and flexural strength in an MD direction, and the coefficient of thermal expansion, flexural modulus, and flexural strength in a TD direction, taking a desired direction as MD and a direction orthogonal thereto as TD for the average values.

### Comparative Example 1

A polyimide sheet was obtained by the same methods as that of the embodiment, except that the MD and TD directions were the same during lamination. The physical properties of the obtained polyimide sheet are listed in Table 1.

TABLE 1

| | Linear | | Average | Average | | | Average | Average | | | Average | Average |
|---|---|---|---|---|---|---|---|---|---|---|---|---|
| | expansion | | value | value | Flexural | | value | value | Flexural | | value | value |
| | coefficient | | +3.0 | −3.0 | modulus | | −0.5 | +0.5 | strength | | −20 | +20 |
| | [ppm/° C.] | | | | [GPa] | | | | [MPa] | | | |
| | MD | TD | — | — | MD | TD | — | — | MD | TD | — | — |
| Example 1* | 9.27 | 9.63 | 12.45 | 6.45 | 6.50 | 6.33 | 5.92 | 6.92 | 251.30 | 249.20 | 230.25 | 270.25 |
| Comparative | 13.81 | 5.89 | 12.85 | 6.85 | 5.77 | 7.11 | 5.94 | 6.94 | 227.17 | 272.40 | 229.79 | 269.79 |
| Example 1 | | | | | | | | | | | | |

*MD and TD in Example 1 indicate a desired direction and a direction orthogonal to that direction.

Based on the results in Table 1, it is evident that the polyimide sheet of the present invention is a polyimide sheet with a linear expansion coefficient of 10 ppm/° C. or less in the in-plane direction.

### (Field of Industrial Use)

The polyimide sheet of the present invention, which was obtained be laminating a plurality of polyimide films, can be used in electronic component applications and the like that require dimensional stability at elevated temperatures.

1. A polyimide sheet formed by laminating at least two polyimide films, such that a thickness of the polyimide sheet is at least 0.2 mm, and a linear expansion coefficient in any two orthogonal directions in a plane is at most 10 ppm/° C.

2. The polyimide sheet described in claim 1, which is obtained by laminating at least two polyimide films having a linear expansion coefficient in the tensile mode in at least one planar direction of at least 10 ppm/° C.

3. The polyimide sheet described in claim 1 or 2, wherein the following relationships apply, when αT is a modulus of elasticity in a direction TD and αM is a modulus of elasticity in a direction MD, in a bend test of a polyimide sheet obtained by laminating polyimide films in a same direction, and when β2 is a modulus of elasticity in a direction orthogonal to β1 and β1, which are moduli of elasticity in desired directions, in a bend test of a polyimide sheet obtained by laminating after rotating each polyimide film to a desired angle:
(αM+αT)/2)−0.5[GPa]≦β1≦(αM+αT)/2)+0.5[GPa],
and
(αM+αT)/2)−0.5[GPa]≦β2≦(αM+αT)/2)+0.5[GPa].

4. The polyimide sheet described in any of claims 1 through 3, wherein the following relationships apply, when yT is a maximum stress in a direction TD and yM is a maximum stress in a direction MD, in a bend test of a polyimide sheet obtained by laminating polyimide films in a same direction, and when δ2 is a maximum stress in a direction orthogonal to δ1 and δ1, which are maximum stresses in desired directions, in a bend test of a polyimide sheet obtained by laminating after rotating each polyimide film to a desired angle:
(γM+γT)/2)−20[MPa]≦δ1≦(γM+γT)/2)+20[MPa],
and
(γM+γT)/2)−20[MPa]≦δ2≦(γM+γT)/2)+20[MPa].

5. A method of manufacturing a polyimide sheet, comprising pressing the polyimide sheet after laminating at least two polyimide films, wherein, when laminating the polyimide films, a film to be laminated is laminated essentially at a 70 to 90 degree angle in a planar direction of the film, centered on a desired point of the laminated film, relative to the laminated film.

6. The method of manufacturing a polyimide sheet described in claim 5, wherein a thickness of the polyimide sheet is at least 0.2 mm, and a linear expansion coefficient in two orthogonal directions in a plane is at most 10 ppm/° C.

7. The method of manufacturing a polyimide sheet described in claim 5 or 6, wherein polyimide films are successively laminated after rotating to a desired angle.

8. A method of manufacturing a polyimide sheet comprising:
i) centering a second film upon a desired point on a first film;
ii) rotating the second film 70 to 110 degrees;
iii) laminating.

9. The method of claim 8 wherein the steps of centering and rotating are repeated for any number of films prior to laminating.
